(19) United States
(12) Patent Application Publication
(10) Pub. No.: US 2005/0062779 A1
(43) Pub. Date: Mar. 24, 2005

(54) Color image processing device and color image processing method

(75) Inventor: Katsushi Mimamino, Kyoto-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/941,533

(22) Filed: Sep. 15, 2004

(30) Foreign Application Priority Data
Sep. 18, 2003 (JP) 2003-325418

(51) Int. Cl. B41J 2/205

(52) U.S. Cl. 347/15; 347/43

(57) ABSTRACT

A color image processing device includes an input unit that inputs color image data, a designating unit that designates a hue range in accordance with a pattern image and a control unit that controls to carry out an image processing of the color image data input by the input unit in accordance with the hue range designated by the designating unit.

### BACKGROUND OF THE INVENTION

1. Field of the Invention

The present invention relates to a color image processing device such as a copy machine, a facsimile machine, a multifunction peripheral having multiple functions, such as a copy function and a facsimile function, and a printer device.

2. Description of the Related Art

In general, a color image processing device converts a scanned input color space (for example, Red, Green and Blue (GRB)) into a color space including lightness and brightness components (for example, Lab or Ycc). Then, after executing a correction process on each of the components of the color space, the input color space is converted into an output color space (for example, Cyan, Magenta, Yellow and blacK (CMYK)), and an image forming process is carried out. In the color image processing device of this kind, conventionally, to designate a color of an output image or the like, a panel having a plurality of color patches for designating a color is provided and a button (key) associated with the color is pressed to designate a color. Alternatively, a color Liquid Crystal Display (LCD) is provided and a plurality of color samples are displayed on the LCD. By touching the color or pressing the associated button, the color is designated.

According to the above-described conventional color image processing device, a special panel or an LCD is necessary for designating and inputting a color which results in the device being expensive. In addition, for designating the color, a color number of the panel or the LCD is input or a certain color is touched. Therefore, only a single color can be designated.

### SUMMARY OF THE INVENTION

The present invention has been made in consideration of the above-described circumstances. An advantage of the present invention is to provide a color image processing device which can easily designate a prescribed color range without using a special mechanism.

According to the present invention, a color image processing device includes a designating unit which can designate a hue range in accordance with a pattern image, and a control unit which carries out image processing of color image data in accordance with the designated hue range.

In the color image processing device of the present invention, the pattern image can include a circular image which the hue changes gradually in a circumferential direction and a value indicating the hue appended to the circular image.

In the above-described color image processing device, since the hue is designated by using the circular image, the range can be designated easily.

According to the color image processing device of the present invention, the designating unit can designate a hue range before conversion and a hue range after conversion. The control unit can convert a hue value of pixels corresponding to the hue range before the conversion into a hue value corresponding to the hue range after the conversion.

The control unit can replace all of the pixels corresponding to the designated hue range with a single hue value. Here, when the single hue value is white, a color erasing function (a function for erasing the hue of the designated range from an original document) can be provided. According to the present invention, not only a single hue value can be designated but also a hue range can be designated. In other words, by selecting (extracting) a region of a specific color, the selected region of the specific color can be converted into a region of a different color (hue converting function). Alternatively, the selected region of the specific color can be converted into a specific single color or erased (color erasing function).

According to the present invention, the color image processing device can also include a storage unit which stores color pattern image data for designating a color and a printing unit which retrieves the stored pattern image data and prints out the pattern image data onto recording paper. Since the color image processing device uses the pattern image printed out by the printing unit, the hue range can be designated most faithfully. Moreover, in the color image processing device, the storage unit can store the pattern image data as data of a color space expressed by hue, saturation and lightness components.

Accordingly, when executing a designated image processing on pixels corresponding to the designated hue range, the data can be handled easily and the structure for processing the data can be simplified.

According to the present invention, a color can be designated by a prescribed range, not by one point of the hue. For example, by designating a color before conversion and a color after the conversion by a range, a processing to convert a hue of a first range into a hue of a second range can be carried out in an original document.

### BRIEF DESCRIPTION OF THE DRAWINGS

FIG. 1 is a block diagram showing a configuration of a color copy machine according to an embodiment of the present invention.

FIG. 2 is a block diagram showing a configuration of an image scanning unit of the color copy machine according to the embodiment of the present invention.

FIG. 3 is a flowchart showing an image forming process carried out by the color copy machine according to the embodiment of the present invention.

FIG. 4 is a flowchart showing a printing process of a pattern image carried out by the color copy machine according to the embodiment of the present invention.

FIG. 5 is a flowchart showing a color conversion process carried out by the color copy machine according to the embodiment of the present invention.

FIG. 6 is a view used for describing a color designation carried out by using a circular pattern image of the color copy machine according to the embodiment of the present invention.

FIGS. 7A and 7B are views used for describing another method of the color designation carried out by using the circular pattern image.

FIG. 8 shows another example of the color designation carried out by using the circular pattern image.

### DETAILED DESCRIPTION OF THE PREFERRED EMBODIMENTS

Embodiments of the present invention will be described hereinafter.

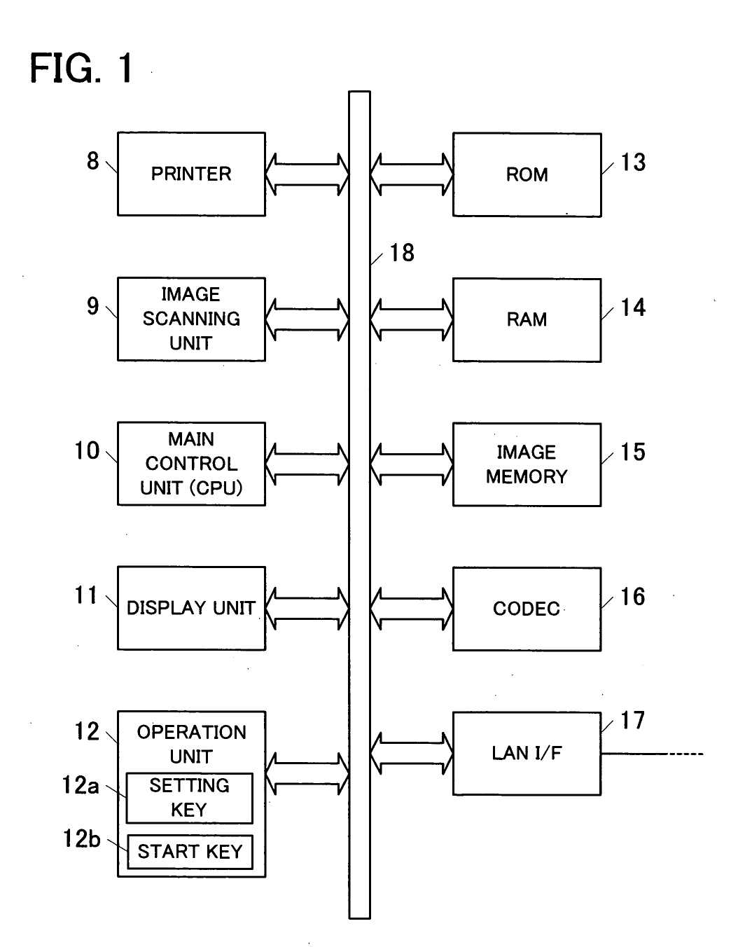

FIG. 1 is a block diagram showing a configuration of a color copy machine according to an embodiment of the present invention. The color copy machine according to the present embodiment includes a printer (image recording unit) 8, an image scanning unit 9, a main control unit (Central Processing Unit (CPU)) 10, a display unit 11, an operation unit 12, a Read Only Memory (ROM) 13, a Random Access Memory (RAM) 14, an image memory 15, a codec 16 and a Local Area Network Interface (LAN I/F) 17.

The printer 8 is an electro-photographic color printer which prints out onto recording paper, a scanned image or image data forwarded from a Personal Computer (PC) or the like through the LAN I/F 17. The printer 8 uses toner of four colors, Cyan, Magenta, Yellow and blacK (CMYK). The printer 8 can carry out a monochrome printing operation by using the toner of only the K (black) component. In addition, the printer 8 can carry out a printing operation using the toner of all four colors, CMYK.

When carrying out a copying process, the image scanning unit 9 optically scans an original document and scans image data. The image scanning unit 9 can also scan a color image. The details will be described later. The main control unit (CPU) 10 is connected to each of the units via a bus 18. The main control unit 10 executes a scanning process, a printing process and other various control processes in accordance with programs stored in the ROM 13. The display unit 11 displays icons and key buttons and also displays messages or the like necessary for an operation. A Liquid Crystal Display (LCD) is mainly used for the display unit 11. However, other display devices such as a Cathode Ray Tube (CRT) display can be used for the display unit 11.

The operation unit 12 includes a setting key 12a for changing a color, a start key 12b and also a ten-key numeric pad, a clear key, a stop key or the like. The setting key 12a is a key operated when carrying out a setting to change a color. The start key 12b is a key operated when starting a copy operation or the like. The ROM 13 stores a program or the like for controlling an operation of the entire color copy machine. The RAM 14 stores data necessary for a control operation of the main control unit 10 and data necessary to be stored temporarily during the control operation. The RAM 14 stores a color pattern image for inputting a designation of a color. The image memory 15 stores under a compressed state, image data scanned by the image scanning unit 9. Furthermore, the image memory 15 stores under a compressed state, image data received via a network from a remote device such as a PC or image data read from a recording media.

The codec 16 encodes the read image data in accordance with the Modified Huffman (MH), Modified Read (MR) or Modified Modified Read (MMR) methods or the like for storing the image data. The codec 16 decodes image data received under a compressed and encoded state for printing out the image data by the printer 8. The LAN I/F 17 exchanges data with a remote device via a LAN. The color copy machine receives a request for a network printing process, a network scanning process or the like from a remote PC via the LAN I/F 17.

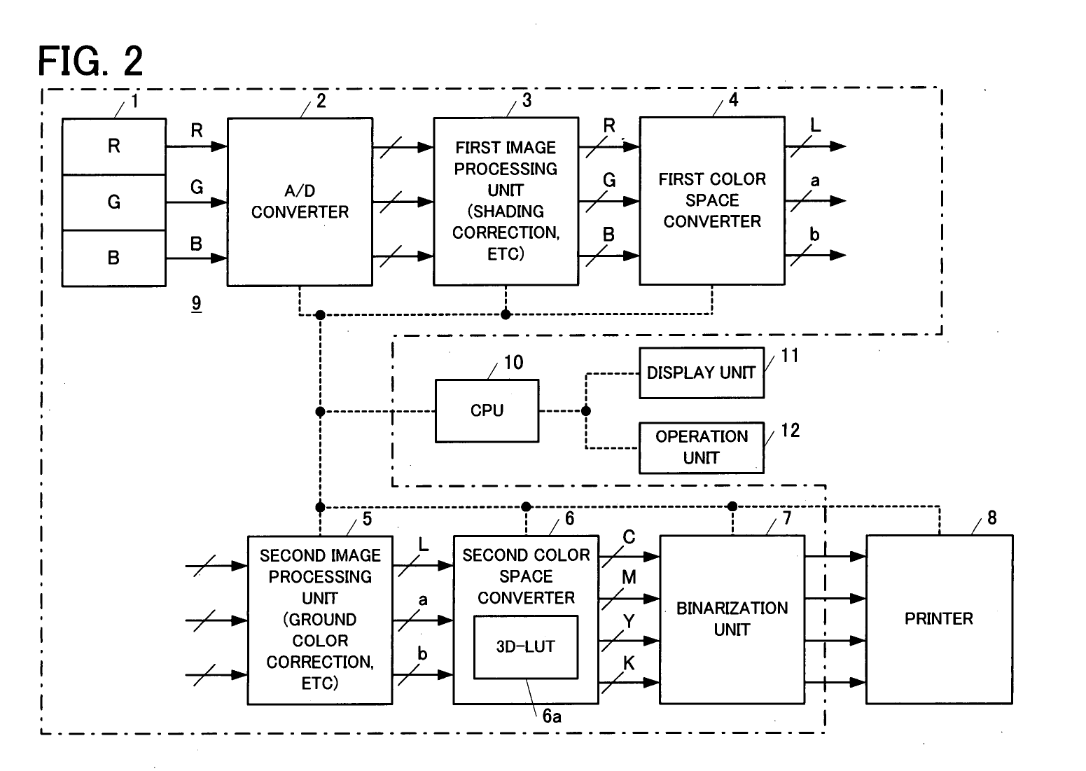

As shown in FIG. 2, the image scanning unit (color image processing circuit) 9 includes a Charge Coupled Device (CCD) 1, an Analog-to-Digital (A/D) converter 2, a first image processing unit 3, a first color space converter 4, a second image processing unit 5, a second color space converter 6 and a binarization unit 7. The CCD 1 functions as a color image data input unit for inputting color image data. The A/D converter 2 includes an Analog Front End (AFE) circuit. Each of the units of the image scanning unit 9 is controlled by the CPU 10. The processed image data is printed out by the printer 8.

The CCD 1 separates one scan line of an original document into Red (R), Green (G) and Blue (B) and scans the original document. After a prescribed period of time, the CCD 1 sequentially scans an image of a next scan line. The AFE circuit amplifies an analog output of the CCD 1. The A/D converter 2 converts the analog signal amplified by the AFE circuit into digital data and outputs it as digital multi-level data. The first image processing unit 3 carries out a processing such as a shading correction and a gamma correction.

The first color space converter 4 converts RGB image data output from the first image processing unit 3 into L, a, b image data which can be expressed by separating a lightness component. The Lab color space is a color space consisting of a coordinate system which expresses saturation and a hue by two parameters, a (R-G axis) and b (Y-B axis), and which lightness L (K-W axis) is added to the parameters. The second image processing unit 5 receives image data of the Lab color space, and executes an image processing such as a ground color correction and a color correction of saturation and a hue or the like, and also changes a color.

The second color space converter 6 receives the image data of the Lab color space, and converts the Lab image data into image data of Yellow, Magenta, Cyan and blacK (YMCK) by interpolation by a 3 Dimension-Look Up Table (3D-LUT) 6a. The binarization unit 7 binarizes and outputs the input CMYK multi-level data.

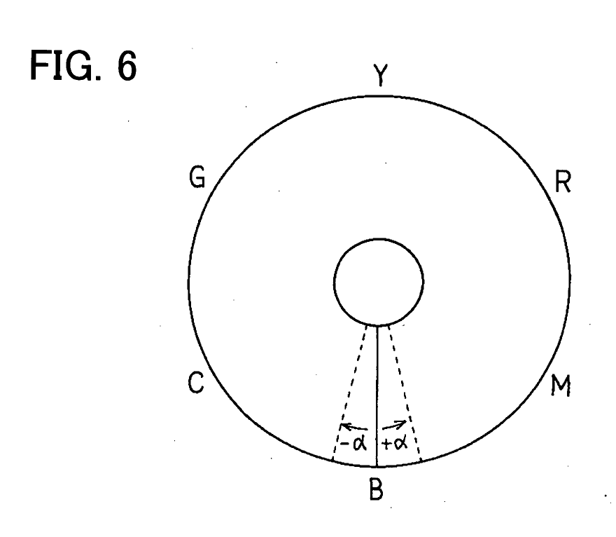

The color copy machine stores color pattern image data for designating a color. When designating a color, the color copy machine can print out the color pattern image data to reference the color pattern image data. As shown in FIG. 6 as an example, the color pattern image data consists of a circular image which the hue (RGB, YCM) changes gradually in a circumferential direction, and a value (angle) indicating the hue appended to the circular image. In FIG. 6, reference numeral R denotes Red, G denotes Green, B denotes Blue, C denotes Cyan, M denotes Magenta and Y denotes Yellow.

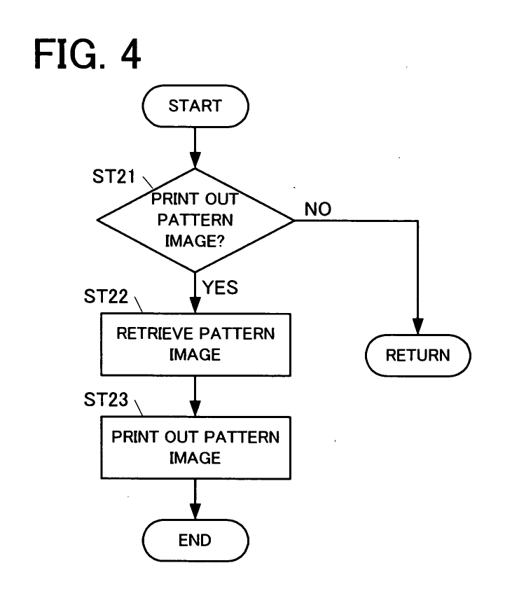

Referring to the flowchart shown in FIG. 4, a process carried out when the color copy machine prints out the pattern image shown in FIG. 6 will be described. When entering into the process routine, at step ST21, a determination is made as to whether or not to print out the pattern image. When a key for instructing to print out the pattern image is operated from the operation unit 12, the determination of whether or not to print out the pattern image at step ST 21 in the flow shown in FIG. 4 results in “YES”. Next, the process proceeds to step ST22. At step ST22, the pattern image data stored in the RAM 14 is retrieved. Next, the process proceeds to step ST23. At step ST23, the pattern image is printed out by the printer 8. In this case, the image data of the pattern image is stored in a form of a color space expressed by a hue (H), saturation (C) and lightness (L). The image data can be stored under a compressed state. In case the image data is compressed, when printing out the pattern image, after expanding the retrieved compressed data, the image data is converted into an output color space (CMYK) and printed out. Further, as described above, since the hue and the saturation can be calculated easily by an ab component of the Lab, the color space expressed by the hue (H), the saturation (C) and the lightness (L) includes the Lab.

The user can input a color designation to the color copy machine in accordance with the printed out pattern image. For example, by inputting an angle of the hue B shown in FIG. 6 as a hue before conversion and inputting an angle of the hue M as a hue after the conversion, the color can be converted from the hue B into the hue M. Here, when the angle of the hue B is designated as the single hue value, a hue range of B±α is designated. When the hue angle M is designated as a single hue value, a hue range of M±α is designated. By changing α, the color range can be changed. In FIG. 6, only the letters of RGB and CMY are shown. However, in the pattern image that is actually printed out, numbers indicating the hue angles are printed around the pattern image of the hue. By using the numbers, a minute color designation can be made. In addition, as described above, just by inputting a single hue value, a hue range having a range of ±α with the single hue value as a standard can be designated.

In the present embodiment, the color image pattern used for the hue designation is stored in the pattern memory and printed out when necessary. However, the color image pattern can be written in an instruction manual in advance. Alternatively, an exclusive sheet displaying the color image pattern can be provided and the color designation can be carried out by using the exclusive sheet. Alternatively, instead of printing out the image pattern stored in the pattern memory, the color image pattern can be displayed on the display unit 7.

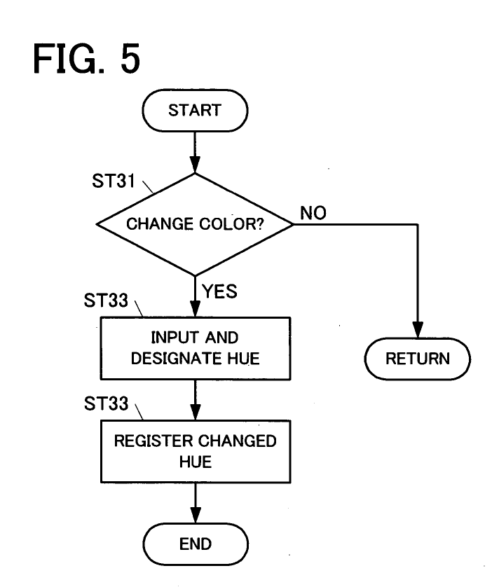

In the color copy machine, when inputting a change of the color by the color designation, the setting key 12a for changing a color is operated from the operation unit 12. Accordingly, the determination of whether or not to change the color at step ST31 in the flowchart of FIG. 5 results in “YES”. Next, the process proceeds to step ST32. At step ST32, first, an angle (for example, B) of the hue before the conversion is input and designated. Then, a target angle (for example, M) of the hue after the conversion is input and designated. Next, the process proceeds to step ST33. At step ST33, the data of the input change of the color is registered with the RAM 14.

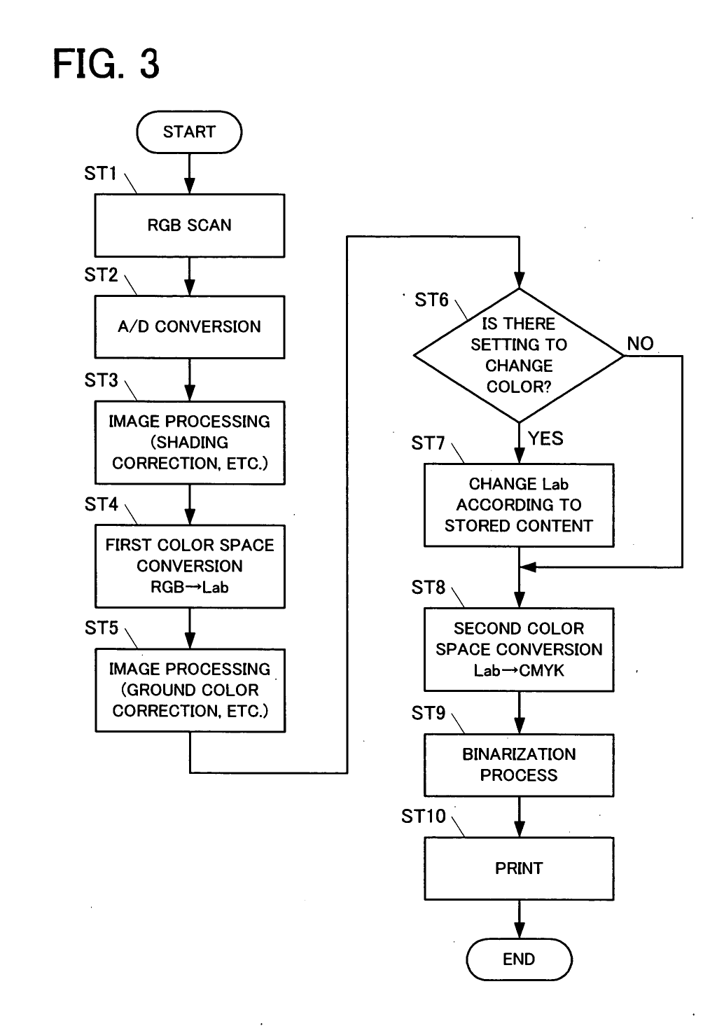

Next, referring to the flowchart shown in FIG. 3, a processing operation carried out when forming an image by the color copy machine will be described according to the present embodiment.

When the start key 12b of the operation unit 12 is pressed, the processing routine starts. At step ST1, an RGB scanning process is executed on the original document by the CCD 1. At step ST2, the RGB image data read by this process is converted into multi-level digital data by the A/D converter 2. Next, the process proceeds to step ST3. The first image processing unit 3 executes a shading correction and a gamma correction on the RGB image data. Then, the image data is input to the first color space converter 4. Next, the process proceeds to step ST4.

At step ST4, the RGB image data is converted into image data of the Lab color space and input to the second image processing unit 5. Next, the process proceeds to step ST5. At step ST5, the second image processing unit 5 executes an image processing such as a ground color correction on the input Lab image data. Next, the process proceeds to step ST6. At step ST6, a determination is made as to whether or not there is a setting to change the color. In case there is a setting to change the color as described in the flowchart of FIG. 5, the process proceeds to step ST7. Meanwhile, in case there is no setting to change the color, the process skips step ST7 and proceeds to step ST8.

At step ST7, a process to change the color is carried out on the Lab data on which the ground color correction or the like has been executed. A pixel value is corrected and calculated so that pixels of a part where the color has been changed become the designated content. Then, the process proceeds to step ST8.

At step ST8, the 3D-LUT 6a interpolates the Lab image data input from the second color converter 6, and the Lab image data is converted into image data of the CMYK color space. Next, the process proceeds to step ST9. At step ST9, the binarization unit 7 binarizes the multi-level CMYK data by using a dither method. Next, the process proceeds to step ST10. At step ST10, the printer 8 prints out the input binary data. The processes of steps ST6 and ST7, in other words, the process to change the color, can be carried out after the process of step ST4.

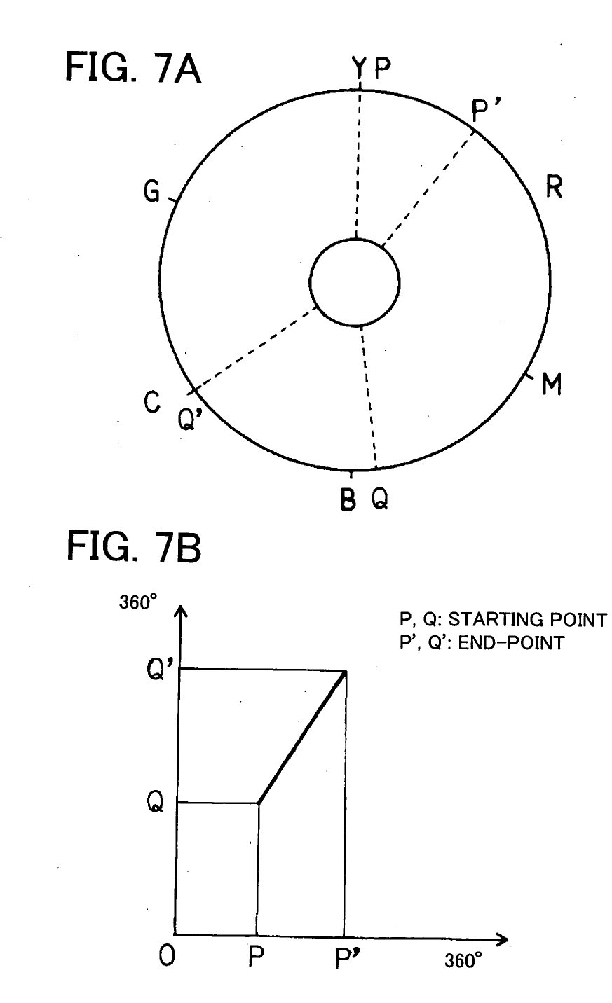

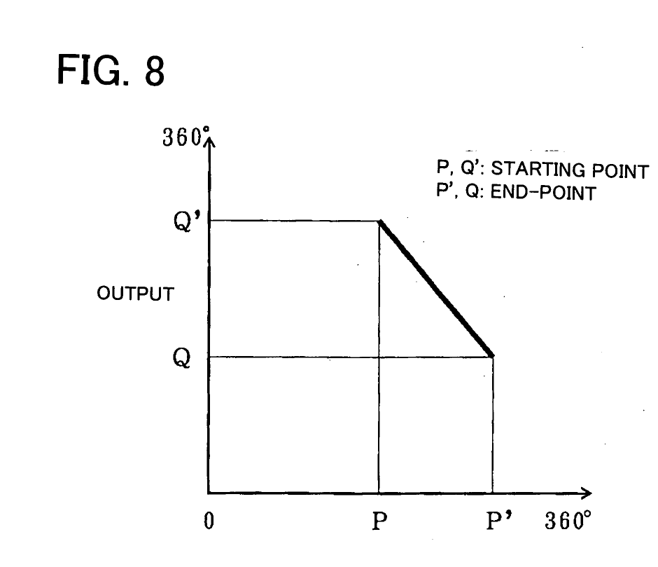

As another method for inputting and designating a color to change the color, as shown in FIG. 7A, to input the color range before the conversion, an angle P indicating a starting point and an angle P′ indicating an end-point can be input for designating the range. To input the target color range after the conversion, an angle Q indicating a starting point and an angle Q′ indicating an end-point can be input for designating the range. Further, in FIG. 7A, reference numeral R denotes Red, G denotes Green, B denotes Blue, C denotes Cyan, M denotes Magenta and Y denotes Yellow. This conversion can also be expressed as shown in FIG. 7B. By looking at the actual hue, the hue can be designated and the target color range can be designated reliably. Further, in FIGS. 7A and 7B, although the angles are indicated only by P, P′ and Q, Q′, in the pattern image that is actually printed out, numeric values indicating the angles in detail are displayed. By switching the relationship between the starting point and the end-point in FIG. 7B, the relationship can be expressed as shown in FIG. 8. In case of FIGS. 6, 7A, 7B and 8, when designating the hue range, the angle value can be input at an interval smaller than the interval of the angle values written in the pattern image. For example, in case the angle values are written for each 10 degrees in the pattern image, an angle value can be input by units of one degree when designating the hue range.

1. A color image processing device, comprising:
means for inputting color image data;
means for designating a hue range in accordance with a pattern image; and
means for controlling to carry out an image processing of the color image data input by the means for inputting in accordance with the hue range designated by the means for designating.

2. The color image processing device according to claim 1, wherein the pattern image includes a circular image which a hue changes gradually in a circumferential direction and a value indicating the hue appended to the circular image.

3. The color image processing device according to claim 2, wherein the value indicating the hue is an angle value indicating a hue angle.

4. The color image processing device according to claim 1, wherein the means for designating can specify the hue range with a designated single hue value as a standard.

5. The color image processing device according to claim 1, wherein the means for designating can specify the hue range in accordance with a designated starting point and an end-point.

6. The color image processing device according to claim 1, wherein the means for designating can designate a hue range before conversion and a hue range after conversion; and
the means for controlling converts a hue value of pixels corresponding to the hue range before conversion in the color image data input by the means for inputting into a hue value corresponding to the hue range after conversion.

7. The color image processing device according to claim 1, wherein the means for designating can designate a hue range before conversion and a single hue value after conversion; and
the means for controlling replaces all pixels corresponding to the hue range before conversion in the color image data input by the means for inputting into a single hue value designated as a hue value after conversion.

8. The color image processing device according to claim 7, wherein the means for designating can designate a hue value corresponding to white as the single hue value after conversion.

9. The color image processing device according to claim 1, further comprising:
means for storing color pattern image data for designating a color; and
means for printing the stored pattern image data onto recording paper by retrieving the stored pattern image data.

10. The color image processing device according to claim 9, wherein the means for storing stores the pattern image data as data of a color space expressed by hue, saturation and lightness components.

11. The color image processing device according to claim 1, wherein the means for inputting is a means for scanning an original document optically and generating the color image data.

12. The color image processing device according to claim 1, wherein the means for inputting is a means for receiving the color image data via a network from a remote device.

13. The color image processing device according to claim 1, wherein the means for inputting is a means for reading the color image data from a recording media.

14. A color image processing method, comprising:
inputting color image data;
acquiring a pattern image for designating a hue range;
designating the hue range in accordance with the pattern image; and
processing the color image data in accordance with the designated hue range.

15. The color image processing method according to claim 14, wherein the pattern image includes a circular image which a hue changes gradually in a circumferential direction and a value indicating the hue appended to the circular image; and
in the step of designating, the hue range is designated by using the value appended to the circular image of the pattern image.

16. The color image processing method according to claim 15, wherein the value indicating the hue is an angle value indicating a hue angle; and
in the step of designating, the hue range is designated by using the angle value appended to the circular image of the pattern image.

17. The color image processing method according to claim 14, wherein the step of designating further comprises:
designating a single hue value; and
specifying the hue range with the designated single hue value as a standard.

18. The color image processing method according to claim 14, wherein the step of designating further comprises:
designating a starting point and an end-point; and
specifying the hue range in accordance with the designated starting point and the end-point.

19. The color image processing method according to claim 14, wherein in the step of designating, a hue range before conversion and a hue range after conversion can be designated; and
in the step of processing, a hue value of pixels corresponding to the hue range before conversion in the color image data is converted into a hue value corresponding to the hue range after conversion.

20. The color image processing method according to claim 14, wherein in the step of designating, a hue range before conversion and a single hue value after conversion can be designated; and
in the step of processing, all pixels corresponding to the hue range before conversion in the color image data is replaced with the single hue value designated as the hue value after conversion.

21. The color image processing method according to claim 20, wherein in the step of designating, a hue value corresponding to white can be designated as the single hue value after conversion.

22. The color image processing method according to claim 14, wherein in the step of acquiring, the pattern image is acquired by retrieving the stored pattern image data and printing the pattern image data onto recording paper.

23. The color image processing method according to claim 22, further comprising storing the pattern image data as data of a color space expressed by hue, saturation and lightness components.

24. A color image processing device, comprising:
an input unit that inputs color image data;
a designating unit that designates a hue range in accordance with a pattern image; and
a control unit that controls to carry out an image processing of the color image data input by the input unit in accordance with the hue range designated by the designating unit.
